(19) United States
(12) Patent Application Publication
(10) Pub. No.: US 2006/0139627 A1
(43) Pub. Date: Jun. 29, 2006

(54) Device and method for inspecting matrix substrate

(75) Inventors: Chih-Cheng Lin, Miao-Li (TW); Tse Wu, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/317,489

(22) Filed: Dec. 23, 2005

(30) Foreign Application Priority Data
Dec. 24, 2004 (TW) 93140471

(51) Int. Cl. G01N 21/88

(52) U.S. Cl. 356/237.1

(57) ABSTRACT

A device (2) for inspecting a matrix substrate (26) includes a light source (22), an electro-optical device (20) determining whether light beams penetrate through or not, a photodetector (23) positioned at one side of the electro-optical device and a host computer (24) connected with the photodetector. A matrix substrate is positioned between the electro-optical device and the light source. The device is used to receive image data, and then the image data is compared with the predefined data to determine whether defects on the matrix substrate exist. Efficiency of inspection can be significantly improved. A related method is also provided.

### BACKGROUND OF THE INVENTION

1. Field of the Invention

The present invention relates to devices and methods for inspecting a matrix substrate, and particularly to a device and method that utilize a light source and an electro-optical device to inspect a matrix substrate.

2. General Background

Liquid crystal displays that are lightweight, thin and portable are widely used in the market. During the process of manufacturing liquid crystal displays, quite a few testing procedures must be performed between various stages in the manufacturing. In particular, a plurality of testing procedures are implemented in the process of manufacturing array of the liquid crystal displays, so that production yield is improved and costs are lowered. Inspecting a matrix substrate generally includes inspecting for defects of a glass substrate such as short circuits or open circuits.

Referring to FIG. 2, a typical device for inspecting a matrix substrate is shown. The device 1 for inspecting a matrix substrate includes an electro-optical device 10, a power supply 11, a light source 12, a photodetector 13, and a monitor 14.

The electro-optical device 10 includes a control layer 101 and a reflective layer 102. The control layer 101 is used to determine whether light beams penetrate therethrough or not. The electro-optical device 10 is positioned a short distance above a matrix substrate 16 under test. The power supply 11 is electrically coupled with the electro-optical device 10 and with pixel electrodes 15 of the matrix substrate 16.

The power supply 11 supplies a voltage between the pixel electrodes 15 of the matrix substrate 16 and the electro-optical device 10 so that an electrical field is generated. The light source 12 emits light beams directed at the electro-optical device 10, and the light beams are reflected by the reflective layer 102. The photodetector 13 is used to receive light beams reflected from the electro-optical device 10, generate signals responsive to the reflected light beams, and supply the generated signals to the monitor 14. If there are defects on the matrix substrate 16, the strength of the electrical field corresponding to the defects is deformed, so that the control layer 101 is activated and an optical transmittance of the control layer 101 is changed. Thus, the reflected light beams received by the photodetector 13 are deformed, and corresponding information is displayed on the monitor 14. In this way, it is determined whether defects exist; and if so, where the defects are. If there are no defects on the matrix substrate 16, the reflected light beams are uniform and clear, and this information is displayed on the monitor 14.

In summary, the light beams are reflected by the electro-optical device 10, and corresponding information is received by and displayed on the monitor 14. As detailed above, the device 1 for inspecting a matrix substrate is able to inspect and detect whether there are defects on the matrix substrate 16. However, if defects exist, the device 1 for inspecting a matrix substrate can generally only identify the approximate locations of the defects, and cannot accurately identify where the defects are. Further, during a process of reworking the defective matrix substrate 16, additional defect-searching procedures may be required. If such procedures are required, costs are increased correspondingly.

Therefore, there is a need for a device and method for inspecting a matrix substrate which can accurately detect where any defects on the matrix substrate are.

### SUMMARY

In a preferred embodiment, a device for inspecting a matrix substrate includes a light source, an electro-optical device determining whether light beams penetrate through or not, a photodetector positioned at one side of the electro-optical device, and a host computer connected with the photodetector. A matrix substrate is positioned between the electro-optical device and the light source.

In another preferred embodiment, a method for inspecting a matrix substrate includes the steps of: positioning a matrix substrate between the light source and the photodetector; switching thin-film transistors on the matrix substrate so that the electro-optical device is activated and at White status or Black status; using a photodetector to take images of the electro-optical device and supply the images into a host computer; and comparing the images with the predefined data to determine whether and where defects of the matrix substrate exist.

The above-described embodiments utilize the photodetector to take images of the matrix substrate and obtain the image data that is displayed on a monitor of the host computer. In addition, comparing the image data saved at the host computer with the predefined data, it is determined whether and where defects of the matrix substrate exist. If the defects of the matrix substrate exist, then where the defects are can be detected dot by dot. Thus, rework process can be implemented in accordance with the result of inspection without the step of inspecting defects on the matrix substrate. Efficiency of inspection can be significantly improved.

Other advantages and novel features will become more apparent from the following detailed description when taken in conjunction with the accompanying drawings, in which:

### BRIEF DESCRIPTION OF THE DRAWINGS

FIG. 1 is a schematic view of a device for inspecting a matrix substrate in accordance with a preferred embodiment of the present invention, together with a matrix substrate; and

FIG. 2 is a schematic view of a device for inspecting a matrix substrate of the prior art, together with a matrix substrate.

### DETAILED DESCRIPTION OF PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims and equivalents thereof.

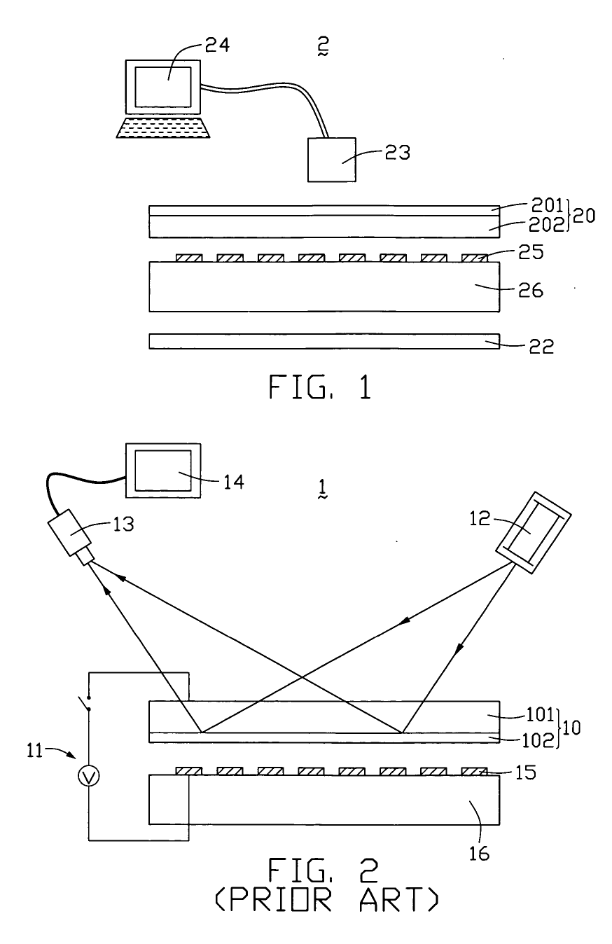

FIG. 1 schematically illustrates a device 2 for inspecting a matrix substrate in accordance with a preferred embodiment of the present invention. The device 2 for inspecting a matrix substrate includes an electro-optical device 20, a light source 22, a photodetector 23, and a host computer 24. The electro-optical device 20 is positioned above a matrix substrate 26, and the light source 22 is positioned below the matrix substrate 26. The light source 22 can be a point light source such as a light-emitting diode, a linear light source such as a cold cathode fluorescent lamp (CCFL), or a planar light source such as an Electroluminescent (EL) device. The matrix substrate 26 typically includes a multiplicity of thin-film transistors (TFTs) 25 thereon.

The electro-optical device 20 includes a transparent conductive layer 201 and a control layer 202. The transparent conductive layer 201 can be made of indium tin oxide (ITO) or indium zinc oxide (IZO). The control layer 202 can be a liquid crystal layer or an anisotropic crystal layer. A voltage is applied at the transparent conductive layer 201 and at the TFTs 25 on the matrix substrate 26 in order to activate or deactivate the TFTs 25 and the light source 22. This switching of the TFTs 25 and the light source 22 determines whether light beams emitted from the light source 22 can penetrate through the electro-optical device 20.

The photodetector 23 can be a charge-coupled device (CCD) camera. A resolution of the CCD camera is higher than a critical dimension of the matrix substrate 26. The host computer 24 provides predefined data relating to the matrix substrate 26, and image data of the matrix substrate 26.

In use of the device 2 for inspecting a matrix substrate, a voltage is applied at the TFTs 25 of the matrix substrate 26 and at the transparent conductive layer 201 of the electro-optical device 20 so that the TFTs 25 and the electro-optical device 20 are activated. The light source 22 emits light beams directed at a bottom surface of the matrix substrate 26. The TFTs 25 are activated so that an electrical field is established between the matrix substrate 26 and the electro-optical device 20, whereby the electrical field activates the control layer 202. In the preferred embodiment, the light beams from the light source 22 can thus penetrate through the electro-optical device 20 so that the electro-optical device 20 is in a WHITE state. The photodetector 23 is utilized to take images of the electro-optical device 20, and to supply corresponding image data to the host computer 24. The image data is processed by the host computer 24 and displayed on a monitor thereof. The image data is compared with the predefined data to determine whether any defects exist in the matrix substrate 26; and if so, where such defects are located. If defects exist, then the locations of the defects are accurately displayed and recorded. Otherwise, if no defects exist, then the TFTs 25 are deactivated, and the electrical field between the matrix substrate 26 and the electro-optical device 20 is changed. Thus the control layer 202 is deactivated, and the light beams from the light source 22 cannot penetrate through the electro-optical device 20 so that the electro-optical device 20 is in a BLACK state. The photodetector 23 is utilized to take images of the matrix substrate 26, and to supply corresponding image data to the host computer 24. The image data is processed by the host computer 24 and displayed on the monitor thereof. The image data is compared with the predefined data to determine whether any defects exist in the matrix substrate 26; and if so, where such defects are located. If defects exist, then the locations of the defects are accurately displayed and recorded. Otherwise, if no defects exist, the testing of the matrix substrate 26 is completed. Thereafter, a next matrix substrate 26 can be provided for testing.

As detailed above, the device 2 for inspecting a matrix substrate utilizes the photodetector 23 to take images of the electro-optical device 20, such images corresponding to the TFTs 25 of the matrix substrate 26. The images are processed by the host computer 24 and displayed on the monitor thereof. The image data is compared with the predefined data of the host computer 24, and differences between the two sets of data are obtained. Thereby, it is determined whether any defects exist in the matrix substrate 26. If defects exist, then the locations of the defects are detected dot by dot. Thus, a reworking process can be implemented in accordance with the results of detection, without the need for a separate step of inspecting defects on the matrix substrate 26. Accordingly, the efficiency of inspection can be significantly improved.

In alternative embodiments, the steps of switching the matrix substrate 26 to be in a WHITE state and to be in a BLACK state by switching the light source 22 can be reversed. The photodetector 23 can instead be a complementary metal oxide semiconductor (CMOS) camera with high resolution.

It is to be further understood that even though numerous characteristics and advantages of various embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

We claim:

1. A device for inspecting a matrix substrate, comprising:
a light source for being positioned at a first side of the matrix substrate;
an electro-optical device, for being positioned at an opposite second side of the matrix substrate, and for determining whether light beams penetrate through the electro-optical device;
a photodetector, for being positioned at one side of the electro-optical device opposite from the matrix substrate; and
a host computer connected with the photodetector.

2. The device as claimed in claim 1, wherein the photodetector comprises a charge-coupled device (CCD) camera or a complementary metal oxide semiconductor (CMOS) camera.

3. The device as claimed in claim 1, wherein a resolution of the photodetector is higher than a critical dimension of the matrix substrate.

4. The device as claimed in claim 1, wherein the electro-optical device includes a transparent conductive layer and a control layer.

5. The device as claimed in claim 4, wherein the control layer is a liquid crystal layer or an anisotropic crystal layer.

6. The device as claimed in claim 4, wherein the transparent conductive layer is made of indium tin oxide (ITO) or indium zinc oxide (IZO).

7. The device as claimed in claim 1, wherein the light source is a point light source.

8. The device as claimed in claim 7, wherein the light source is a light-emitting diode.

9. The device as claimed in claim 1, wherein the light source is a linear light source.

10. The device as claimed in claim 9, wherein the light source is a cold cathode fluorescent lamp.

11. The device as claimed in claim 1, wherein the light source is a planar light source.

12. The device as claimed in claim 11, wherein the light source is an electroluminescent (EL) device.

13. A method for inspecting a matrix substrate having thin-film transistors, the method including the steps of:
positioning the matrix substrate between a light source and an electro-optical device;
switching the thin-film transistors to activate the electro-optical device so that the electro-optical device is in a WHITE state or a BLACK state;
using a photodetector to take an image of the electro-optical device, and supplying corresponding image data to a host computer; and
comparing the image data with predefined data to determine whether one or more defects of the matrix substrate exist; and if so, where the one or more defects exist.
